(19) United States
(12) Patent Application Publication
(10) Pub. No.: US 2026/0102640 A1
(43) Pub. Date: Apr. 16, 2026

(54) Lineman Fall Restraint

(71) Applicant: Line Systems LLC, Gilbert, AZ (US)

(72) Inventor: Trenton Schindler, Gilbert, AZ (US)

(73) Assignee: Line Systems LLC, Gilbert, AZ (US)

(21) Appl. No.: 18/913,826

(22) Filed: Oct. 11, 2024

(51) Int. Cl. A62B 35/00

(52) U.S. Cl. CPC A62B 35/0068; A62B 35/0075

(57) ABSTRACT

A lineman fall restraint includes a first strap and a second strap connected to said first strap. It further includes a first cam assembly having a through passage. The first strap extends through the passage. A first lanyard first strap and a second lanyard second strap each connect to a portion of the lineman fall restraint. A first loop strap portion of the first strap forms a first portion of a closeable loop. A second loop strap portion of the second strap forms a portion of the closeable loop. The closeable loop adjustable to and from a closed loop and open loop.

### I. FIELD

The disclosure concerns a lineman fall restraint. The lineman fall restraint couples a lineman to a pole while allowing the lineman to climb the pole and restrict and arrest the fall of the lineman off or down the pole should the lineman lose her footing.

### II. BACKGROUND

U.S. Pat. No. 6,752,242, Jun. 2, 2002, Buckingham Manufacturing Co., Inc., discloses a wood pole fall protection device for line technicians and pole climbers that allows travel up and down a wooden pole without incurring a fall or injury. The wood pole fall protection device is also designed to provide the line technician with the ability to rotate or twist in the straps as well as negotiate and maneuver around obstacles and obstructions encountered upon the pole.

Canadian Patent Application 2676507, Feb. 26, 2010, the Southern Company, discloses a fall arrest system adapted to prevent the falling of a lineman/pole climber from a wooden structure. The fall arrest system is connectable to a body belt of the climber, which is strapped about the waist of the climber. The fall arrest system includes at least two outer straps and at least two bias members, or springs, in communication thereto for on-the-fly adjustment of a loop to surround the wooden structure to be climbed.

US Patent Publication 2010/0078261, Apr. 1, 2010, the Southern Company, concerns a fall arrest system for climbing a variety of structures. The system can comprise an inner strap assembly and an outer strap assembly. The inner strap assembly and the outer strap assembly can be coupled and can substantially form a loop which can encircle the object to be climbed, e.g. a pole. The outer strap assembly can comprise a first outer strap and a second outer strap. The first outer strap can be pivotally coupled to an adjusting element. The second outer strap can pass through, and be slidably engaged with, an adjusting element. This can enable the second outer strap to be frictionally coupled to the first outer strap. The outer strap assembly can comprise a strong, stiff, yet flexible material. For example, the first outer strap and the second outer strap can comprise nylon or polypropylene webbing, reinforced fabric, leather, polyester, plastic, rubber, metal and/or combination thereof. The inner strap assembly can comprise a supple, yet strong material, such as, for example and without limitation, rope or cord comprising nylon, polyester, Kevlar, cotton, or combinations thereof.

U.S. Pat. No. 8,544,603, Oct. 1, 2013, Buckingham Manufacturing Co., Inc., discloses a fall restriction apparatus for climbers of wooden poles having a connecting component adapted for connection to and retention within a center opening of a three slot-opening D-ring. The connecting component is sized so that when inserted within the central opening, it is restrained from rotating. The connecting component may have outwardly directed protrusions on at least its spine region. The affixed D-ring shape typically lies in a major plane orthogonal to a plane in which the remainder of the connecting component lies. Alternately, the connecting component may be attached to other openings of the three-opening D-ring. The fall restriction apparatus also contains a buckle assembly which may have one or more cleats disposed on a rear surface to facilitate gripping a wooden pole.

U.S. Pat. No. 10,099,087, Oct. 16, 2018, Buckingham Manufacturing Co., Inc., discloses a pole climbing fall prevention assembly having a pole strap, lanyard, and cam assembly that permits adjustment of the pole strap, a lever is attached to the sidewall of the cam assembly to ease the task of a climber needing to adjust the pole strap. A second lever can be attached to the second sidewall of the cam assembly to provide easier access to the lever regardless of the orientation of the cam assembly relative to the climber.

U.S. Pat. No. 10,207,151, Feb. 19, 2019, Buckingham Manufacturing Co., Inc., discloses a pole fall restriction assembly comprising an outer strap, an inner strap/lanyard adjustably interconnected to the outer strap by a cam buckle and connector 18 (e.g., a D-shaped carabineer), a D-ring, and adjustable connector assembly for interconnecting inner strap/lanyard to a climber's body belt. With the pole fall restriction assembly, a worker climbing a pole will be tethered and supported relative to the pole as s/he ascends and descends the pole.

US Patent Publication 2019/0060683, Feb. 28, 2009, Buckingham Manufacturing Co., Inc., discloses a fall arrester used by utility lineman, communications and telecommunication workers that comprises a body defined by a pair of spaced apart frame members bridged by a floor, and a cam pivotally mounted to the body and sandwiched between the frame members. The cam includes teeth formed on its cam end and an eye formed at the end of the lever end. A rope passes between the frame members and between the cam and floor of the body.

### III. SUMMARY

A lineman fall restraint that achieves at least some of the advantages of the invention includes a first strap and a second strap connected to said first strap. The first strap has a first and a second end. The second end of said first strap resides at a loop formed by the first strap. The second strap passes though the loop. A first cam assembly has a through passage through which said first strap extends through. A first lanyard first strap and a second lanyard second strap each connect to a portion of said lineman fall restraint. A first loop strap portion of the first strap forms a first portion of a closeable loop. The closeable loop is adjustable to and from a closed loop and an open loop. A second loop strap portion of said second strap forms a second portion of said closeable loop. The lineman fall restraint includes a first surface delimiting a first though opening. The second strap extends through the first through opening. A closeable loop connector extends through said first through opening. When the closeable loop is adjusted to a closed loop, the closeable loop connector connects to the lineman fall restraint at the first cam assembly. When the closeable loop is adjusted to the open loop, the closeable loop connector is disconnected from the lineman restraint at the first cam assembly.

The lineman fall restraint includes a first handle that connects to the first strap at a first connection point. The first connection point is at said first loop strap portion of the first strap. The handle also connects to the first strap at a second connection point. The second connection point is at the first loop strap portion of said first strap. The first connection point is upstream of the first strap second end. The second connection point is upstream of the first connection point.

Naturally, further objects of the invention are disclosed throughout other areas of the specification, drawings, photographs, and claims.

### IV. BRIEF DESCRIPTION OF THE DRAWINGS

FIG. 1 is a top down isometric view of a lineman fall restraint embodying features of the invention; the restraint includes a closeable loop in an open loop orientation; a closeable loop connector unlocked and disconnected from a portion of the closeable loop at a first cam assembly.

FIG. 2 is a top down isometric view of the lineman fall restraint shown in FIG. 1; the closeable loop resides in a closed loop orientation snugly about a perimeter of a telecommunications wood pole; a first loop strap portion snugly fits about the pole's perimeter and resides at a 12 o'clock position; a second loop strap portion snugly fits about the pole's perimeter and resides at a 6 o'clock position; a first handle resides at a 9 o'clock position; the closeable loop connector resides at a 3 o'clock position and closes the loop at the first cam; the lineman fall restraint resides in an operationally installed orientation; the lineman purposely omitted for ease of reference; the circumference of the wood pole is exaggerated as is the length of the first and second loop portions for ease of. The components are not to scale.

FIG. 3 is a side isometric view of a lineman in the process of installing the lineman fall restraint about the wood pole and adjusting the length of a lanyard strap by positioning a second cam assembly with a second cam assembly positioner.

FIG. 4 is a side isometric view of the lineman and lineman fall restraint of FIG. 3; the lineman fall restraint adjusted so the first and second lanyard straps are taut and connected to the lineman; and a gap exists between the perimeter of the pole and the second loop strap.

FIG. 5 is a side isometric view of the lineman and lineman fall restraint of FIG. 4; the lineman pulling on the first cam assembly positioner to shorten the of the first loop strap about the pole and eliminate the gap shown in FIG. 4; a secondary safety strap is shown for completeness.

FIG. 6 is a top down isometric view of the lineman and lineman fall restraint shown in FIG. 5; the lineman on the pole and the lineman restraint adjusted to reside in the operationally installed orientation; the second strap omitted for ease of reference.

FIG. 7 is a side view of the lineman and lineman fall restraint oriented to show the lineman climbing the pole and moving the closed loop up the pole.

FIG. 8 is a side view of a cam assembly with the cam biased in a first position free of a strap.

FIG. 9 is the side view of the cam assembly with the cam maximally rotated in a clockwise direction to a first maximally rotated position free off a strap.

FIG. 10 is first end view of the cam assembly shown in FIG. 8 rotated in a counterclockwise direction with teeth of the cam biting into a strap.

FIG. 11 is first end view of the cam assembly shown in FIG. 8.

FIG. 12 is the first end view of the cam assembly shown in FIG. 8 with the cam maximally rotated in the clockwise direction.

FIG. 13 is the first end view of the cam assembly shown in FIG. 12 with the cam maximally rotated in the counterclockwise direction.

FIG. 14 is the first end view of the cam assembly shown in FIG. 1 with the cam rotated in the clockwise direction and on a strap.

Before any embodiments of the invention are explained in detail, it is to be understood that the invention is not limited in its application to the details of construction and arrangement of components set forth in the following description or as illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. The terms “over”, “under”, “around”, “about”, “overlap”, “resides”, “in”, “delimits”, “between”, “form” and “abut” include both partially and completely. They further include both directly and indirectly. The term “ring” is not limited to a circular item; rather it can take on many shapes such as oblong, a “D” shape, a square, triangle or rectangle.

### V. DETAILED DESCRIPTION OF THE INVENTION

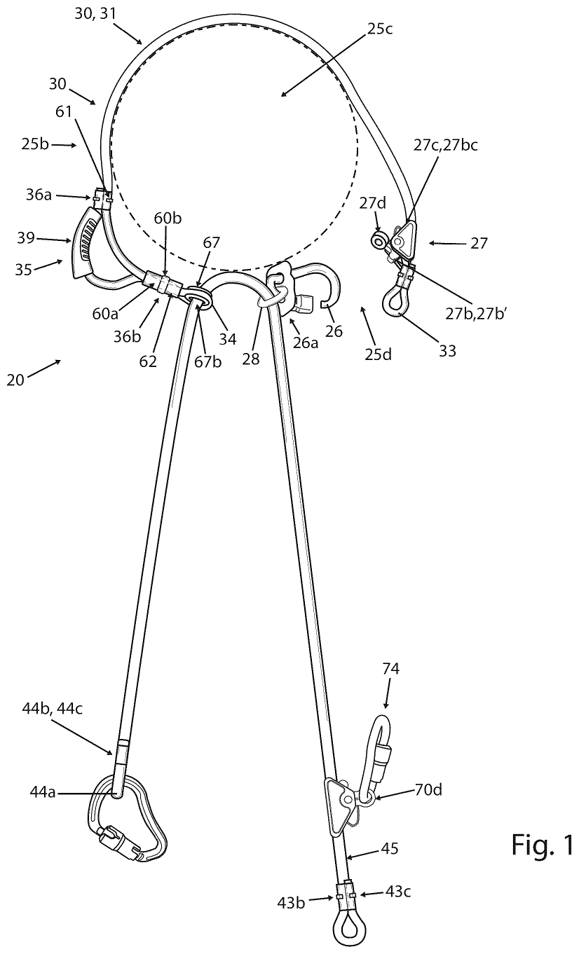

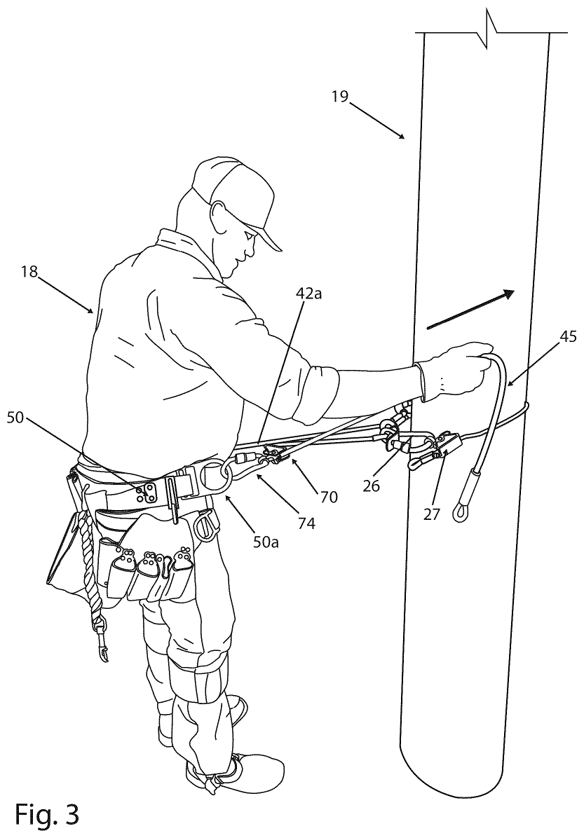

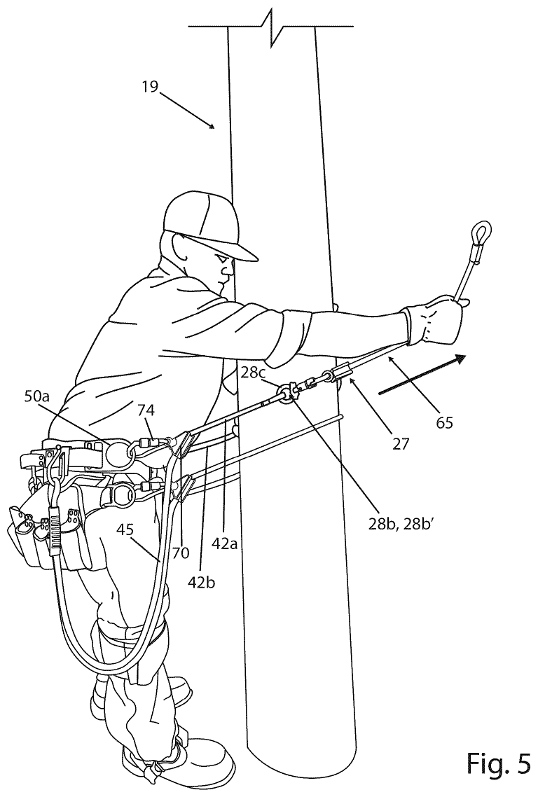

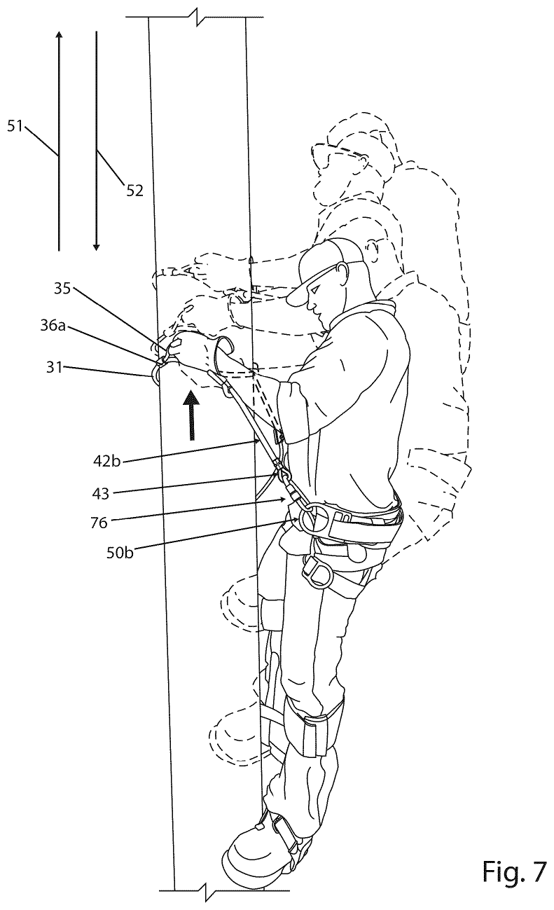

FIGS. 1 through 14 disclose a lineman fall restraint (20). The term “lineman” used herein is broad enough to include line technician, utility lineman, communication technician and pole climber. The term “restraint” and restrainer as used herein is broad enough to include arrestor or arrest. The term “pole” includes the traditional wood pole used to carry power, communication and/or data lines. The pole can include structure to aid a technician to climb the pole like pegs. The fall restraint includes a first strap coupled to a second strap. The term “strap” as used herein is broad enough to include cord, rope and cable. The first strap can be called an outer strap, and the second strap can be called an inner strap.

Structure of the lineman fall restrain comprises a closeable loop (25). The closeable loop is adjustable to and from a closed loop (25a) and open loop (25b). When adjusted to an open loop (25b) from a closed loop (25a), a closeable loop connector (26) which closes the loop is disconnected. The disconnection uncouples a portion of the structure (27) forming the closed loop (25a) from another portion (28) of structure which also forms the closed loop (25a). To adjust the open loop to a closed loop, one reconnects the closeable loop connector (26) connects the portion of the structure (27) forming the closed loop (25a) to the other structure (28) forming the closed loop (25a).

The closeable loop (25) when it forms an open loop (25b) includes structure (26, 27, 28, 30, 31, 40) which delimits an open area (25c) into which a climbable pole (19) may pass. A user can pass the structure (26, 27, 28, 31, 32, 41) which delimits the open area (25c) partially about the pole (19) by moving the structure (26, 27, 28, 31, 32, 41) to pass the pole into the delimited open area through the delimited opening (25d) delimited by the closeable loop connector (26) and structure (27). When the closeable loop (25) is adjusted to a closed loop orientation (25a) from an open loop orientation (25b), the delimited opening (25d) is closed by the closeable loop connector (26). Upon closing the delimited opening (25d), the structure of the lineman fall restraint forming the closeable loop forms a 360% perimeter. The structure forming the closed loop can extend about and surround a perimeter of the pole (19). The structure includes (26, 27, 28, 31, 32, 41).

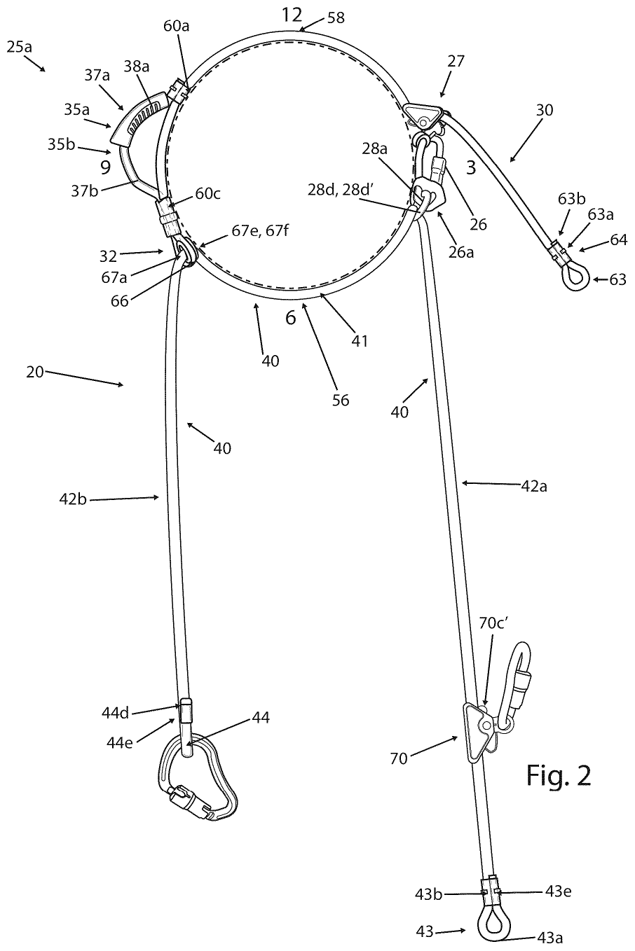

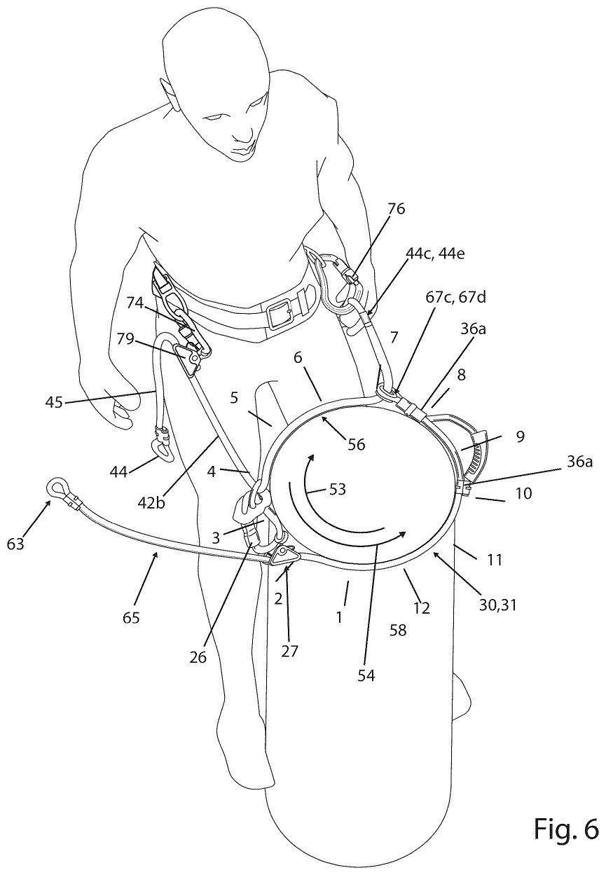

A first cam assembly (27) couples to the first strap (30) and is slidably positional to various positions along the length of the first strap (30). The first strap (30) extends through a through passage (27a) delimited by surface of the first cam assembly. The user (18), such as the lineman, through adjusting the position of the first cam assembly (27) along the length of the first strap (30) can shorten or lengthen a portion of the first strap (31) which serves to form or forms the closeable loop (25). The portion (31) of the first strap (30) that serves to form or forms the closeable loop can be called the first loop strap portion (31). To shorten the length of the first loop strap portion (31), a user (18) slides the first cam assembly (27) along the length of the first strap (30) in a direction away from a first strap first end (33) towards a first strap second end (34). To increase the length of the first loop strap portion (31), a user slides the first cam assembly (27) along the length of the first strap (31) in a direction away from the first strap second end (34) towards the first strap first end (33). The first cam assembly (27) allows a user (18), as explained more fully below, when the closeable loop (25) resides in the closed loop orientation (25a) and surrounds the perimeter of the pole (19), to adjust the length of the first loop strap portion (31) about the pole (19) to orient the lineman fall restraint (20) into an operationally installed orientation. See FIGS. 2 and 6.

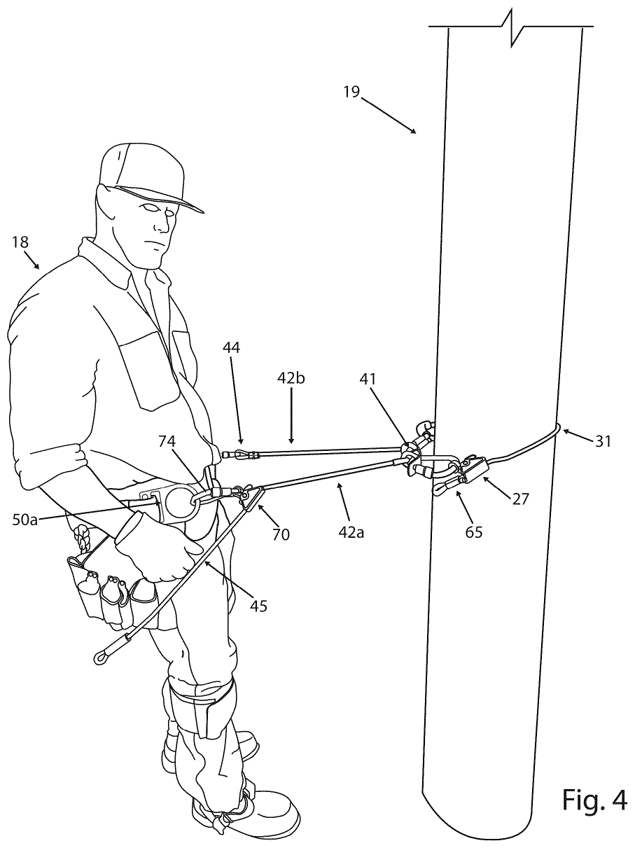

Generally, during adjustment of the lineman fall restraint to the operationally installed orientation, a user adjusts the lineman fall restraint (20) from a partially installed orientation to the operationally installed orientation. See FIG. 4. In the partially installed orientation, the closeable loop (25) resides in the closed loop orientation (25a) (closed loop) and surrounds the pole (19). A lanyard (42a, 42b) of the lineman fall restraint (20) is connected to a lineman belt (50) around the body of the lineman (18). The user, such as a lineman, during the process of adjusting the lineman fall restraint (20) into the operationally installed orientation, can be on the ground or on the ground and on the pole during various stages of adjustment of the lineman fall restraint (20).

Now in more detail, during the process of adjusting the orientation of the lineman fall restraint from the partially installed orientation to the operationally installed orientation, the lineman (18) adjusts the position of the first cam assembly (27) along the length of the first strap (30) in a downstream direction along the first strap (30) away from the first strap end (33) towards the first strap second strap second end (34); the positioning of the cam assembly shortens the length of the portion of the first strap forming the closed loop (31). The lineman shortens the first loop strap portion (31) to a climbing length so that the closed loop (25a) forms a climbing perimeter about the pole (19). The length is short enough, so that in the operationally installed orientation, the first strap portion forming the closed loop (31) abuts up against and abuts about the pole (19). The closed loop (31) makes frictional contact with the pole (19). The length is also short enough, in the installed orientation, so that a gap between a portion of the second strap forming the closed loop portion (41) (second loop strap portion) and the pole closes. The second loop strap portion, with the gap closed, abuts up against and abuts about the pole (19). It makes frictional contact with the pole.

At the start of the shortening of the length of the first loop strap portion and closing of the gap between the second loop strap portion (41) and the pole (19), the lineman fall restraint (20), resides in the partially installed orientation. In the partially installed orientation, the lanyard (42a, 42b) formed by a portion of the second strap (40) connects to the lineman's belt (50). The belt (50) about the body of the lineman (18). The lanyard forms a taut connection between the belt (50) and the second loop strap portion (41). The lanyard (42a, 42b) is taut. The second loop strap is taut (41). There is a gap between the second loop strap portion (41) and the pole (19). The lineman can be on the ground and leaning back and at a climbing length form the pole (19).

A user, to fine tune the operationally installed orientation, can make a series of adjustments to shorten the length of the lanyard and shorten the length of the first loop strap portion (31). The adjustments make sure the lanyard (42a, 42b) holds the lineman body, when in a leaned back position, at the climbing length from the pole.

The abutting of the first loop strap portion (31) and the second loop strap portion (41), while the lanyard remains taut and at a climbing length, ensures the first loop strap portion (31) and the second loop strap portion (21) provide enough forces against and with the pole to restrain the lineman whose climbing up the pole from falling down the pole, when the lineman loses her footing and even her grip on the handles (26, 35).

The abutting of the first (31) and second (41) loop strap portions still allows the lineman, during the climbing of the pole, when the lineman fall restraint resides in the operationally installed orientation, to move the closed loop (25a) in a first axial direction (51) towards a first end of the pole and away from a second end of the pole. The lineman fall restraint (20) also allows movement of the closed loop (25a) in a second axial direction (52) opposite the first direction. It also allows the lineman to rotate the closed loop (25a) relative to the pole in either a first rotational direction (53), clockwise, or a second rotational direction (54) opposite the first rotational direction counterclockwise direction.

Generally when the lineman is in the process of moving the closed loop (25a) in the first axial direction (51), second axial direction (52), first rotational direction (53), or second rotational direction (54), the lineman leans towards the pole and places slack in the lanyard (42a, 42b). The slack allows the lineman to move the first loop strap portion (31) off the pole in a lateral direction during movement of the closed loop (25a) in the first axial direction (51), second axial direction (52) or about the pole in the first (53)or second (54) rotational directions. The term “off” includes partially or completely “off”.

The handles (26, 35) facilitate the movement of the first (31) and second (41) loop strap portions of the closed loop and the entire closed loop (25a) in the first axial direction (56) up the pole and in the second axial direction (58) down the pole. The first handle (35) can be a left hand handle. The second handle (26) can be a right hand handle.

When the lineman fall restraint resides in the operationally installed orientation, a first positional point (56) of the second loop strap portion (41), as a point of reference, always resides at around the 6 o'clock portion. A second positional point (58), opposite the first positional point on the first loop strap portion (31) resides at around the 12 o'clock position. As the closed loop (25a) rotates about the pole, the 6 o'clock position and the 12 o'clock position remain fixed at the first (56) and second (58) positional points. The positional points exist when the lineman fall restraint resides in the operationally installed orientation. The lineman is generally in the 6 o'clock position when the lineman fall restraint resides in the in the operationally installed orientation, the lineman is at least partially up the pole at least 1.5 times her height, the body leaned back and angled relative to the pole, the weight of the body imparting a force on the lanyard (42a, 42b) to make it, the second loop strap (41) and the first loop strap (31) taut. Further the lineman is with proper footing on pegs.

The first handle (35), when the lineman fall restraint (20) resides in the operational installed orientation and the lineman at least 1.5 time her height up the pole, resides, relative to the first (56) and second (58) positional points, at a position from the 7 o'clock to the 11 o'clock position relative to the positional points at the 6 o'clock and 12 o'clock positions. More particularly, the handle resides from the 8 o'clock to the 10 o'clock position. Even more particularly, the handle resides from the 8.5 o'clock position to the 9.5 o'clock position. Preferably the handle resides at the 9 o'clock position. A point along ⅔ of the length of the handle, wherein the ⅔ length includes a midpoint of the handle, can reside from or between the above recited o'clock positions. A point along ½ of the length of the handle, wherein the ½ length includes a midpoint of the handle, can reside from or between the above recited o'clock positions. A point along ¼ of the length of the handle, wherein the ¼ length includes a midpoint of the handle, can reside from or between the above recited o'clock positions.

The second handle when the lineman fall restraint resides in the operationally installed orientation, and the lineman 1.5 times her height up the pole, resides at a position from the 5 o'clock to the 1 o'clock position relative to the positional points at the 6 o'clock and 12 o'clock positions. The positional points exist when the lineman restraint resides in the operationally installed orientation. More particularly the handle resides from the 4 o'clock to the 2 o'clock position. Even more particularly, the handle resides from the 4.5 o'clock position to the 2.5.5 o'clock position. Preferably the handle resides at the 3 o'clock position. A point along ⅔ of the length of the spine of handle, wherein the ⅔ length includes a midpoint of the spine, can reside from or between the above recited o'clock positions. A point along ½ of the length of the spine, wherein the ½ length includes a midpoint of the spine, can reside from or between the above recited o'clock positions. A point along ¼ of the length of the spine, wherein the ¼ length includes a midpoint of the spine, can reside from or between the above recited o'clock positions.

Now referring to the structure of the first handle in more detail, the first handle includes a first handle portion (35a) and a second handle portion (35b). The first handle portion (35a) connects to the first loop strap portion (31) at a first connection point (36a) at the first loop strap portion (31). The second handle portion (35b) connects to the first loop strap portion (31) at a second connection point (36b) at the first loop strap portion (31). The first connection point (36a) is at a place on the first loop strap portion (31) upstream of the second end (34) of the first strap (30). The second connection point (36b) is at a place on the first loop strap portion (131) upstream of the first connection point (36a). The term “upstream”, relative to the first strap (30), means the direction moving away from the first strap second end (34) along the first strap (30) towards the first strap first end (33). The term “downstream” means the direction moving away from the first strap first end (33) along the first strap (30) towards the first strap second end (34).

The first handle portion (35a) includes a first extension (37a), which forms a first strap portion of the handle (38a). The first strap portion (38a) of the handle (35) extends away from a gripping portion (39) of the handle (35) to the first connection point (36a) at the first loop strap portion (31). The gripping portion (39) extends about a portion of the first extension (37a). The portion of the first extension (37a), over which the gripping portion (39) extends, forms a portion of the first strap portion(38a). The first strap portion (38a) is continuous. The second handle portion (35b) includes a second extension (37b), which forms a second strap portion (38b) of the handle (35). The second strap portion (38b) of the handle (35) extends away from the gripping portion (39) to the second connection point (36b) at the first loop strap portion (31). The gripping portion (39) extends about a portion of the second extension (37b). The portion of the second extension (37b), over which the gripping portion (39) extends, forms a portion of the second strap portion (38b). The second strap portion (38b) is continuous. The first (38a) and second (38b) strap portions are continuous with each other.

In more detail the first handle portion (35a) and the second handle portion (35b) of the first handle forms a continuous elongated handle portion (35a, 35b). The continuous elongated handle portion includes a continuous elongated handle strap (38a, 38b).

The first handle (35), the first handle portion (35a), the second handle portion (35b), the continuous elongated handle portion (35a, 35b), the continuous elongated handle strap (38a, 38b), first extension of the handle (37a,), second extension of the handle (37b), first strap portion (38a) of the handle, second strap portion (38b) of the handle, and gripping portion (39) of the handle each overlap the first loop strap (31) along its length.

A first handle clamp (61) connects a first end (60a) of the handle (35) to a portion of the first loop strap portion (31 at the first connection point (36a). The first end (60a) of the handle is itself a portion of the first strap (30) and continuous therewith. Thus the first handle clamp (61) connects, in overlapping relation, a portion (60a) of the first strap (30) upstream of the first strap second end (34) to another portion (31′) of the first strap (30) also upstream of the second end (34). The first connection point (36a) resides proximate the first strap second end (34) and distal the first strap first end (33). The proximate and distal positions being measured along the length of the first strap (30).

A second handle clamp (62) connects a second end (60b) of the handle to a portion of the first loop strap (31) at the second connection point (36b). The second end (60b) of the handle (35) is itself a portion of the first strap (30) and continuous therewith. Thus the second handle clamp (62) connects, in overlapping relation, a portion (60b) of the first strap upstream of the first strap second end (34) to another portion (31″) of the first strap also upstream of the second end (34). The other portion (31″) of the first strap also upstream of the first connection point (36a). The second connection point (36b) resides proximate the first strap second end (34) and distal the first strap first end (33). The proximate and distal positions being measured along the length of the first strap (30).

The distance between the first connection point and the second connection point measured along the length of the first strap is equal to or greater than 3 cm and less than or equal to 6 cm. More particularly it is equal to or greater than 5 cm and less than or equal to 7 cm. Still more particularly is equal to or greater than 7 cm and less than or equal to 11 cm. The first handle has a longitudinal length measured from the first connection point to the second connection point equal to or greater than 10 cm and less than or equal to 13 cm. Preferably, the distance is 17 cm. The first end of the resides at the first connection point. The second end of the handle resides at the second connection point.

The first connection point can be a distance upstream from the first strap second end from 4 cm to 11 cm. More particularly 8.5 cm. The first connection point can be a distance from the first strap first end of from 72 cm to 120 cm. More particularly about 92 cm.

The first strap first end (33) resides at a head of a first loop (63) formed by overlapping portions (63a) of the first strap. The overlapping portions close the loop at its base (63b). A clamp (64) connects the overlapping portions (63a) together to fix the base (63b) relative to the head.

The clamp (64) proximate the first strap first end (33) provides an abutment or stop to prevent the first strap (30) from passing through the through passage delimited by surface of the first cam assembly (27). The first cam assembly through passage (27a) includes a first access (27b′) at the first end (27b) of the cam assembly. It also includes a second access (27c′) at a second end (27c) of the first cam assembly (27). The portion of the first strap (30) downstream of the second access (27c′) and second end (27c), to first strap second end (34), forms the first loop strap portion (31). Thus the portion of the first strap from the first cam assembly second end (27c) and to first strap second end (34) forms the first loop strap portion (31). The first strap second end resides (34) at the first loop strap portion. The portion of the first strap upstream of the first access (27b′) and first cam assembly first end (27b) forms and a first cam positioner (65). The first strap first end (33) resides at the first cam positioner (65).

A first surface (28a) delimits a first through opening (28b). The first surface can be continuous and curvilinear. The first entrance includes a first access (28b′) at the first side (28c) and a second access (28d′) at the second side (28d). A first ring (28) forms the first surface and the first through opening. The second strap (40) passes through the first through opening (28b) of the first ring (28).

The closeable loop connector (26) forms part of the closeable loop (25). It connects to the first ring (28), through which the second strap (40) passes. The connector (26) connects to the first ring (28) by passing through the first through opening (28b) of the first ring (28) through which the second strap (40) also extends. The connector (26) rather than passing through the ring opening (28b) can connect to the ring (28) by being integral with the ring.

The closeable loop connector (26) also connects to the first cam assembly (27) through which the first strap (30) passes. The first strap (30) passes through the first cam assembly through passage (27a). The closeable loop connector (26) connects to the first cam assembly at the lever (27d) of the cam assembly. A portion of the lever includes a surface (27e) which delimits a lever through opening (27f). The surface can be continuous and curvilinear. The closeable loop connector (26) extends through the lever through opening (27f). The closeable loop connector (26) is a carabiner with an open position and a locked closed position. The carabiner (26) in the open position can disconnect from the cam assembly (27) by passing the surface (27e), which delimits the lever through opening (27f), through the carabiner opening. The disconnection places the closeable loop (25) in the open loop (25b) orientation. The user can then pass the pole through the opening delimited by structure of the lineman restraint which forms the closeable loop. A user, once the lineman fall restraint is in position, can then lockingly connect the carabiner to the portion of the lever forming the lever through opening to form the closed loop (25a).

The closeable loop connector (26) forms the second handle of the lineman fall restraint (20). The second handle can include padding (26a) at the end of the handle. The padding can be a soft leather or a fibrous pillow.

To move the first cam assembly (27) towards the first strap second end (34) and away from the first strap first end (33), and thus shorten the length of the first loop strap portion (31), a user pulls the first strap (30) through the first cam assembly though passage (27a) and away from the first cam assembly first end (27b); and towards the first strap second end (34). The portion of the first strap (30) pulled is the first cam assembly positioner (65). The positioner (65) is pulled away from the first cam assembly (27) and away from the closeable loop connector (26). During adjustment of the first cam assembly (26) towards the first strap second end (34), the length of the first loop strap portion (31) shortens, and the length of the first cam assembly positioner (65) increases. The length of the first strap (30) from the first end (33) to the second end (34) remains unchanged.

As stated the length of the first loop strap portion (31) is made short enough by the user so that the first strap portion (31) forming the closed loop abuts up against and about the pole (19). It makes frictional contact with the pole (19). The length is also short enough to abut the portion of the second strap (41) forming the closed loop portion (second loop strap portion (41)) up against and about the pole (19). It makes frictional contact with the pole (19). As stated previously, the shortening of the length of the first loop strap portion (31) takes place when a lanyard (42a, 42b) formed by a portion of the second strap connects to the lineman's belt (50). The belt about the body of the lineman (18); the lanyard (42a, 42b) forming a taut connection to the second loop strap portion (41). The lanyard (42a, 42b) is taut, and the second loop portion is taut (41). The lineman (18) can be on the ground. The lineman has adjusted the lanyard straps (42a, 42b) of the lanyard to the lineman climbing length.

The first strap second end (34) resides at a head of overlapping portions of the first strap forming a second loop (66). The overlapping portions close the loop at a loop base (66c). The overlapping portions forming the base includes a first strap overlapping portion (66a) and a second strap overlapping portion (66b). The first strap overlapping portion (66a) connects to the first handle (35) at the handle first end (60a) and is continuous with the handle first end (60a). The second strap overlapping portion (66b) connects to the portion of the first strap overlapped by the handle first end (66a) at the first connection point (36a) and is continuous therewith. The first handle clamp (61) connects, in an overlapping orientation, the first strap overlapping portion (66a) to the second strap overlapping portion (66b).

Surface of the first strap forming the second loop (66), at which the first strap second end (34) resides, itself resides, in a race (67). The race (67) can be curvilinear. The race can be continuous. The race resides about a second surface (67a) connected to the race (67). The second surface (67a) can be continuous and curvilinear. The second surface (67a) delimits a second through opening (67b). The second through opening has a first access (67c) at the first side (67d) and a second access (67e) at a second side (67f) through which the second strap (40) passes. A second ring (32) forms the race (67) and second surface (67a) and second through opening (67b). The second strap (40) passes through the second ring through opening (67b). The second strap (40) thus connects to the first strap (30) by passing through the first strap's second loop (66) and second ring (32) in the second loop (66).

Now referring to the second strap (40) in more detail, the second strap has a first end (43a) and a second end (44a). The first end of the second strap resides at a head of a loop (43) formed by the second strap (40). The loop is formed by overlapping portions (43b, 43c) of the second strap (40). The overlapping portions close the loop at a loop base (43d). A clamp (43e) connects the overlapping portions (43b, 43c) together in overlapping fashion. The clamp can be a fibrous winding. The second end (44a) of the second strap (40) resides at a head of a second loop (44) formed by the second strap (40). The loop is formed by overlapping portions (44b, 44c) of the second strap. The overlapping portions close the loop at a loop base (44d). A clamp (44e) connects the overlapping portions together in overlapping fashion. The clamp (44e) can be a fibrous winding.

The second strap (40), upstream of the loop (43) at which the first end (43a) of the second strap resides, extends through a second cam assembly through passage (70a) delimited by surface of the second cam assembly (70). The second cam assembly (70) includes a first access (70b′) into the through passage (70a) at a first end (70b) of second cam assembly. The second cam assembly includes a second access (70c′) into the through passage (70a) at a second side (70c). A portion of the second strap (40) extends from the second cam assembly (70) downstream to the first ring (28) and forms a first lanyard strap (42a). The first lanyard strap (42a) being part of the lanyard (42a, 42b).

A second cam assembly positioner (45) of the second strap and continuous with the first lanyard strap (42a), extends from the second strap first end (43a) downstream to the second cam assembly (70). The clamp and or loop (43; 43e), at the first end (43a) of the second strap (40), can form an abutment to prevent the second strap (40) and its first end (43a) from passing through the second cam assembly through opening (70a) and being uncoupled from second cam assembly (70). A first lanyard connector (74) connects to the first lanyard strap (42a) at the second cam assembly (70). The connector (74) connects to the cam assembly at the lever (70d) of the second cam assembly. A portion of the lever includes a surface (70e) which delimits a lever through opening (70f). The surface can be continuous and curvilinear. The first lanyard connector extends through the lever through opening. The first lanyard connector (74) is a carabiner with an open position and a locked closed position. The carabiner in the open position can connect to a first belt connector (50a) of the lineman's belt (50) worn about the body of the lineman. To connect the carabiner, a user orients the carabiner in the open position. The user then orients the structure forming the first belt connector (50a) into the carabiner (74). The user then closes the carabiner into the locked position to surround the structure forming the belt connector. The belt connector (50a) can be a D ring.

A second lanyard connector (76) extends through the opening of the second lanyard strap loop (43). The second lanyard connector (76) is a carabiner with an open position and a locked closed position. The carabiner (76) in the open position can connect to a second belt connector (50b) of the lineman's belt worn about the body of the lineman. To connect the carabiner, a user orients the carabiner in the open position. The user then orients the structure forming the second belt connector (50b) into the carabiner. The user then closes the carabiner into the locked position to surround the structure forming the belt. The belt connector (50b) can be a D ring.

A lineman shortens or increases the length of the first lanyard strap (42a) and second lanyard strap (42b) by adjusting the position of the second cam assembly (70) along the length of the second strap (40). The second cam assembly (70) is slidingly moved along the length of the second strap (40) in a downstream direction towards the second strap second end (44a) form the second strap first end (43a). To move the second cam assembly (70) towards the second strap second end (44a), a user pulls the second strap (40) through the second cam assembly through passage (70a) and the second strap first end (43a) away from the second cam assembly (70). During adjustment of the second cam assembly (70) moves towards the second strap second end (44a), the length of the first lanyard strap (42a) shortens and the length of the second cam assembly positioner (45) increases. The length of the second strap (40) remains unchanged. To adjust the first lanyard strap (42a) to have the same length as the second lanyard strap (42b), a user pulls the second strap (40) through the first ring (28) and second ring (32) and the first carabiner (74) away from the first ring (28).

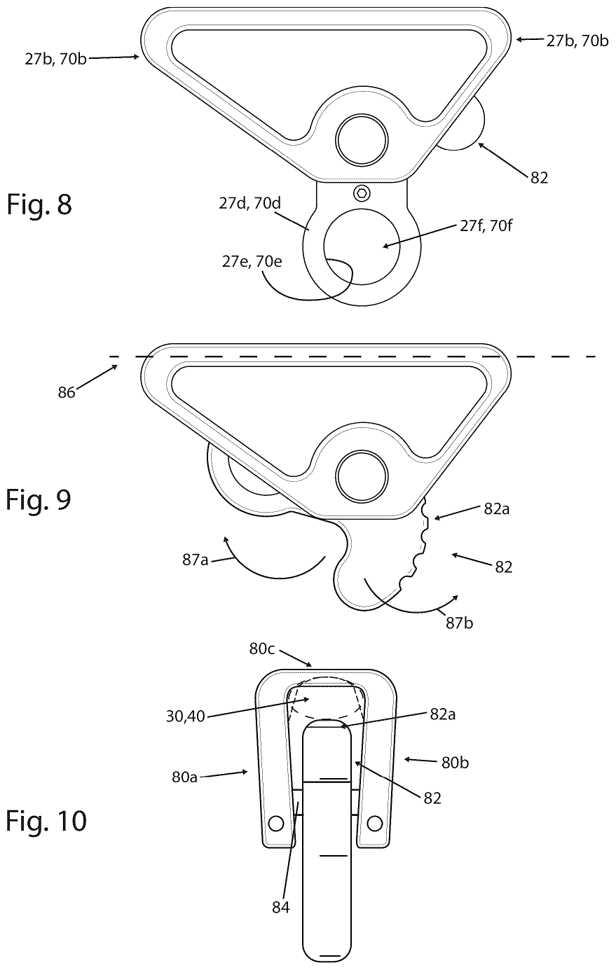

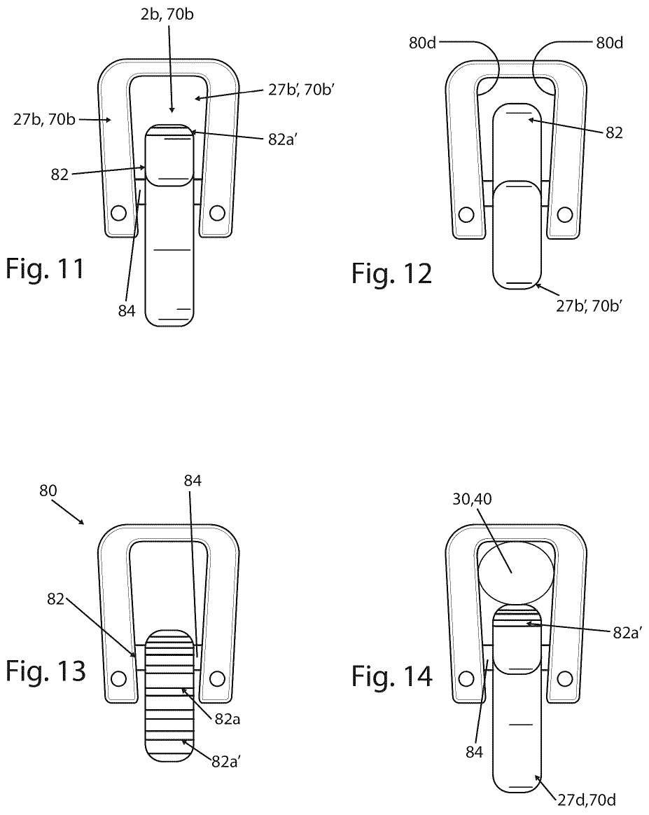

In more detail, the first (27) and second (70) cam assemblies have similar function and structure. The cam assemblies (27), (70) each comprise a body (80), a cam (82), a lever (70d) (27d), a pivot (84), a spring and delimiting surface (27e), (70e) which delimits the lever through opening (27f), 70f). The body (80) includes a first wall (80a) spaced a distance in the lateral direction from a second wall (80b). The lateral direction is relative to the longitudinal direction (86) in which the cam assembly through passage extends. A third wall (80c) interconnects the first (80a) and second sidewalls (80b) and spans the lateral distance from which the first sidewall (80a) is spaced from the second sidewall (80b). Each wall's first surface (80d) delimits open space between the first surfaces. The pivot (84) which can be a pin extends in the lateral direction in the open space (80e). The pin (84) extends into an opening (80f) delimited by the first wall (80a) and an opening (80g) delimited by the second wall (80b). The cam (82) includes a curved surface which forms a plurality of teeth (82a). Each tooth of the plurality spaced from adjacent teeth of the plurality along the curved surface. The cam (82), cam teeth (82a), and lever (70d), (27d) are pivotable in a first rotational direction (87a) about the pin and an opposite second rotational direction (87b) about the pin. The spring biases the cam to reside in a first off the strap position when the strap is off the first cam assembly. In the first position, a first plurality (82a′) of the plurality of teeth (82a) reside in a first off the strap position along a rotational path when the strap is off the first cam assembly. See FIGS. 8 and 11. The position between where the teeth (82a′) reside along the rotational path when the cam maximally rotated in the first (87a) or second (87b) directions. See FIGS. 12 and 13.

The spring biases the cam in a first strap installed position. The cam is in the first strap installed position when the strap (30); (40) extends through the cam through passage (27a); (70a) and when there is slack in the second loop strap (31) and slack in the first lanyard strap (42a) and second lanyard strap (42b). See FIG. 14. In the first strap installed position the first plurality of teeth (82a′) are rotated in the first direction (87a) compared to their position when the cam resides in the first off the strap position. See FIG. 11. The cam (82) is in a second strap installed position when the strap (30); (40) extends through the cam assembly through passage (27a); (70a) the first loop strap portion abuts against the pole, the second loop strap portion abuts to the pole, the first lanyard strap, the second lanyard strap, the first loop strap portion and second loop strap portion taut, the lineman restraint resides in the operationally installed orientation, and the lineman on the pole in a leaned back position. See FIG. 6. In the second strap installed position, at least some of the first plurality of teeth (82a′) of the plurality of the teeth (82a) push into the strap with enough force to lock the cam assembly (27); (70) in position along the strap (30); (40). The teeth rotated in the first direction (87a) from the first strap installed position, but not maximally rotated in the first direction (87a).

To use and operate the lineman fall restraint, a user such as a lineman, fastens the lineman's belt (50) around her body; connects the first lanyard connector (74) to the lineman first belt connector (50a); connects the second lanyard connector(76) to the lineman second belt connector (50b); adjusts the closeable loop (25) into a closed loop (25a) surrounding the pole; positions the first cam assembly (27) to reside proximate the first strap first end (33) and distal the first strap second end (34). The lineman positions the second cam assembly (70) along the second strap (40) to adjust the first lanyard strap (42a) and second lanyard strap (42b) to each extend a first length from its respective ring (28, 32). The lineman adjusts the length of the lanyard straps (42a, 42b) so that the lanyard straps (42a, 42b) and second loop strap portion (41) are taut as the lineman (18) leans back from the pole (19). The lineman repositions the first cam assembly (27) along the length of the first strap (30) towards the first strap second end (34) to abut the second loop strap portion (41) up against and abut about the perimeter surface of the pole (19). The abutting eliminates a gap between the second loop strap portion (41) and pole (19). The adjustment towards the second end (34) also tightly abuts the first loop strap portion (31) against and about the pole (19). The lineman positions the first handle at the 9 o'clock position and the second handle at the 3 o'clock position relative to the 6 o'clock first positioner (56) and the 12 o'clock second positioner (58). The lineman can further reposition the second cam assembly (70) to adjust the length of the lanyard straps (42a, 42b) and the first cam assembly (27) to fine tune the operationally installed orientation. The lineman can do the further adjustment while on the ground or on the pole.

If the lineman (18) loses her footing and falls of the pegs after climbing the pole a distance greater than her 1.5 times her height and let's go of the handles (26, 35), the lineman (18) imparts a force on the second cam assembly lever (70d) and the lanyard straps (42a, 42b) in the second axial direction (52). The force on the second cam assembly lever (70d) and rotates the cam (82) in the second rotational direction (87b) the cam teeth (82a) locks the cam assembly in place on the first lanyard strap (42a). The second strap imparts a force in the second axial direction (52) first and second rings. The first ring (28) imparts a force on the closeable loop connector (26) in the second axial direction (52). The closeable loop connector (26) imparts a force on the cam lever (27d) in the second axial direction (52) which the cam assembly translates to a rotational force (87b) on the lever (27d) and cam (82) in the second rotational direction (87b). A plurality (82a′) of the plurality of teeth (82a) bite into the first strap (30) locking the first cam assembly (27) in place on the first strap (30). The forces provide abutment forces and force of friction between the first (31) and second (41) loop strap portions and pole (19). The abutment and friction forces restrain and prevent the closed loop (25a) from sliding down the pole (19).

In the above example the first strap (30), including the first loop strap portion (31) and the first cam assembly positioner (65) is a cord. The cord (30, 31, 65) is continuous. The first handle's continuous strap portion (38a, 38b) first extension (37a), second extension (37b), first strap portion of the handle (38a), and second strap portion of the handle (38b), is a cord. The cord (37a, 37b, 38a, 38b) is continuous. The handle cord (37a, 37b, 38a, 38b) is a part of the first strap cord (30, 31, 65) and continuous therewith. Although these items are a continuous cord. They can be cords coupled together. The cord can comprise nylon, polyester, Kevlar, cotton, or combinations thereof. In one example the cord can include a core of parallel polyester filament bonded with rubber based adhesive. It can be wrapped in rubber tape. It is further over braided with a tough polyester sleeve. It is entirely saturated with rubber solution. The first cam assembly (27) can be called a robe grab.

In the above example the second strap (40), including the second loop strap portion (41) and the second cam assembly positioner (45) is a rope. Although these items (40, 41, 45) are a continuous rope; they could be ropes coupled together. The rope can comprise comprising nylon, polyester, Kevlar, cotton, or combinations thereof. The rope(s) can include a layer which forms an external surface of the rope. The formed external surface provides a hard surface as compared to rope without the layer. The hard surface resists wear. The surface can be formed from a coating or layering. These rope(s) can be a continuous cord or cords. The cord can include a core of parallel polyester filament bonded with rubber based adhesive. It can be wrapped in rubber tape. It is further over braided with a tough polyester sleeve. It is entirely saturated with rubber solution. The cord can include nylon, polyester, Kevlar, cotton, or combinations thereof. The second cam assembly (70) can be called a robe grab.

The particular embodiments or elements of the invention disclosed by the description or shown in the figures accompanying this application are not intended to be limiting, but rather exemplary of the numerous and varied embodiments generically encompassed by the invention, or equivalents encompassed with respect to any particular element thereof. In addition, the specific description of a single embodiment or element of the invention may not explicitly describe all embodiments or elements possible; many alternatives are implicitly disclosed by the description and figures.

Each element of an apparatus or each step of a method may be described by an apparatus term or method term. Such terms can be substituted where desired to make explicit the implicitly broad coverage to which this invention is entitled. As but one example, all steps of a method may be disclosed as an action, a means for taking that action, or as an element which causes that action. Similarly, each element of an apparatus may be disclosed as the physical element or the action which that physical element facilitates. As but one example, the disclosure of a lineman fall restraint should be understood to encompass disclosure of the act of “restraining the lineman from falling” whether explicitly discussed or not—and, conversely, were there effectively disclosure of the act of “connecting”, such a disclosure should be understood to encompass disclosure of a “connector” and even a “means for connecting”. Such alternative terms for each element or step are to be understood to be explicitly included in the description.

In addition, as to each term used unless its utilization in this application is inconsistent with such interpretation, common dictionary definitions should be understood to be included in the description for each term as contained in the Random House Webster's Unabridged Dictionary, second edition, each definition hereby incorporated by reference.

When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Further, for the purposes of the present invention, the term “coupled” or derivatives thereof can mean indirectly coupled, coupled, directly coupled, connected, directly connected, or integrated with, depending upon the embodiment.

Additionally, for the purposes of the present invention, the term “integrated” when referring to two or more components means that the components (i) can be united to provide a one-piece construct, a monolithic construct, or a unified whole, or (ii) can be formed as a one-piece construct, a monolithic construct, or a unified whole. Said another way, the components can be integrally formed, meaning connected together so as to make up a single complete piece or unit, or so as to work together as a single complete piece or unit, and so as to be incapable of being easily dismantled without destroying the integrity of the piece or unit.

The claims set forth in this specification are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon. The elements following an open transitional phrase such as “comprising” may in the alternative be claimed with a closed transitional phrase such as “consisting essentially of” or “consisting of” whether or not explicitly indicated the description portion of the specification.

Additionally, the claims set forth in this specification are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A lineman fall restraint comprising:
a first strap;
a second strap connected to said first strap;
a first cam assembly having a through passage, said first strap extends through said through passage;
a first lanyard first strap and a second lanyard second strap each connected to a portion of said lineman fall restraint.

2. The lineman fall restraint of claim 1, wherein a first loop strap portion of said first strap forms a first portion of a closeable loop, said closeable loop adjustable to and from a closed loop and open loop.

3. The lineman fall restraint of claim 2, wherein a second loop strap portion of said second strap forms a second portion of said closeable loop.

4. The lineman fall restraint of claim 3, wherein,
when said closeable loop adjusted to a closed loop;
a closeable loop connector connects to said lineman fall restraint at said first cam assembly;
said first loop strap portion of said first strap forms a portion said closed loop; and
said second loop strap portion of the second strap forms a portion the closed loop.

5. The lineman fall restraint of claim 4, wherein when said closeable loop adjusted to said open loop, said closeable loop connector disconnected from said lineman restraint at said first cam assembly.

6. The lineman fall restraint of claim 5, comprising a first surface delimiting a first though opening, said second strap extending through said first through opening, said closeable loop connector extending through said first through opening.

7. The lineman fall restraint of claim 6, wherein said first strap comprising a first and a second end.

8. The lineman fall restraint of claim 7, wherein said first strap comprising:
first and second overlapping portions continuous with each other and forming a loop; said second end of said first strap at said loop, said second strap passing though said loop.

9. The lineman fall restraint of claim 8, comprising:
a second surface delimiting a second through surface said second strap extending though said second through opening.

10. The lineman fall restraint of claim 9, wherein said loop comprises a surface that resides in a race, said race connected to and about said second surface delimiting said second through opening.

11. The lineman fall restraint of claim 9, wherein said second loop strap portion of said second strap forming said portion of said closed loop between said first and second through openings.

12. The lineman fall restraint of claim 9, wherein said first lanyard strap is continuous with said second loop strap portion of said second strap forming said closed loop; said first lanyard strap resides between said first surface forming said first through opening and a first end of said second strap; and said second lanyard strap is continuous with said first portion of said second strap forming of said portion of said closed loop; said second lanyard strap resides between said second surface forming said second through opening and a second end of said second strap.

13. The lineman fall restraint of claim 9, wherein said second loop strap portion of said second strap forming said portion of said closed loop between said first lanyard strap and said second lanyard strap, and continuous with both said first and second lanyard straps.

14. The lineman fall restraint of claim 9, comprising:
a first handle, connects to the first strap at a first connection point, said first connection point at said first loop strap portion of said first strap forming said first portion of said closeable loop, said first handle also connects to said first strap at a second connection point, said second connection point at said first loop strap portion of said first strap forming said first portion of said closeable loop, said first connection point upstream of first strap second end, said second connection point upstream of said first connection point.

15. The lineman fall restraint of claim 14, wherein said handle comprising:
a first strap portion at the first connection point;
a second strap portion at the second connection point; and wherein
said first and second strap handle portions form a continuous handle strap.

16. The lineman fall restraint of claim 14, wherein said first connection point spaced apart from said second connection point measured along the length of the first strap a distance of at least 4 cm.

17. The lineman fall restraint of claim 16, wherein when said lineman fall restrain adjusted to an operationally installed orientation:
a positional point along said second loop strap portion of the second strap forming said second portion said closeable loop at a 6 o'clock position;
a positional point along said first loop strap portion said portion of said first strap forming said second portion said closeable loop at a 12 o'clock position relative to said 6 o'clock position;
a 12 cm continuous length of said continuous handle strap of said first handle encompassing a midpoint of said handle, said midpoint being the midpoint of the length of said continuous handle strap measured from said first connection point to said second connection, point resides at a 9 o'clock position relative to said 6 and 12 o'clock positions;
said closeable loop connector resides at a 3 o'clock position relative to said 6 and 12 o'clock positions.

18. The lineman fall restraint of claim 17, wherein the first strap handle portion is continuous with the first overlapping portion of the first strap.

19. The lineman fall restraint of claim 17, wherein,
said first strap, including it first loop strap portion of the first strap forming the first portion of the closeable loop, the first loop strap portion of the first strap forming said portion closed loop;
the continuous handle strap are a cord; and
the second strap and its second loop strap portion of the second strap forming the second portion of the closeable loop; the second loop strap portion of the second strap forming said portion said closed loop; said first lanyard strap; and said second lanyard strap are a rope.

20. A method of using a lineman restraint comprising:
fastening a lineman's belt around a body of a lineman;
connecting a first lanyard connector to a lineman first belt connector;
connecting a second lanyard connector to a lineman second belt connector;
adjusting a closeable loop into a closed loop with a closeable loop connector to surround a telephone wood pole with the closed loop;
positioning a first cam assembly to reside proximate a first strap first end and distal a first strap second end;
positioning a second cam assembly along a second strap to adjust a first lanyard strap and a second lanyard strap to each extend a first length from a respective ring so that the lanyard straps and a second loop strap portion of a second strap are taut as the lineman leans back from the pole and a gap exists between the second loop strap portion and the pole;
repositioning the first cam assembly along the length of the first strap towards the first strap second end until the second loop strap portion abuts up against and abuts about a perimeter surface of the pole abutting, eliminating the gap between the second loop strap portion and pole;
positioning a portion of the second loop strap portion at a 6 o'clock first position;
positioning a portion of the first loop strap portion at a 12 o'clock position relative to the 6 o'clock position; and
positioning a first handle at a 9 o'clock position and the closeable loop connector at a 3 o'clock position relative to each other and relative to the 6 and 12 o'clock position.
